(19) United States
(12) Patent Application Publication
(10) Pub. No.: US 2020/0268493 A1
(43) Pub. Date: Aug. 27, 2020

(54) Portable Water Flosser

(71) Applicant: Wensheng Vincent Kuang, Valencia, CA (US)

(72) Inventor: Wensheng Vincent Kuang, Valencia, CA (US)

(21) Appl. No.: 16/284,014

(22) Filed: Feb. 25, 2019

(51) Int. Cl. A61C 17/02

(52) U.S. Cl. CPC A61C 17/0214; A61C 17/0202

(57) ABSTRACT

A portable water flosser or dental cleaning device, which directs water from a faucet onto teeth without using an electrically operated pump, is made of a hose, a water jet tip member, and a tightening means. The hose at its small end is coupled with the water jet tip member and at its large end is loosely fit onto the neck of the faucet, leaving the faucet's nozzle completely inside the hose. The hose is fastened around the faucet's neck by the tightening means, which can be a piece of rope or a clip, so the faucet water is directed to the water jet tip member. The device fits with all types of faucets.

### FIELD OF THE INVENTION

This invention relates generally to dental cleaning devices without using an electrically operated pump, and particularly to a portable dental cleaning device that directs water from a faucet onto teeth.

### BACKGROUND OF THE INVENTION

It is simple, convenient, and economical to directly use faucet water to clean teeth without using an electrically operated pump. This can be done by connecting a hose to the faucet's nozzle and the water can be directed onto the teeth. There would be no problem to make such a water flosser if there is only one type of faucet nozzle. However, faucet nozzles in different shape and size are used everywhere, therefore fitting a hose onto more than one type of faucet nozzles can be a problem.

Disclosed in the US Pat. No. 2,208,031 (Cleaning Spray), a faucet connector constructed of soft rubber is used to force fit onto the outlet of various size faucets. However, the fitting only works to a few faucets whose outlets are not much different in size and shape. In another U.S. Pat. No. 9,375,299 (Water Floss Pick), a similar type of fitting to a faucet's nozzle is also disclosed.

Disclosed in the U.S. Pat. No. 4,941,459 (Dental Hygiene Device), a screw fit coupling is used to connect a hose to a faucet's nozzle. The screw fitting only works with a certain type of faucets. In another U.S. Pat. No. 4,650,470 (Portable Water-jet System), a screw fitting also is used to connect a hose to a faucet's nozzle.

Disclosed in the U.S. Pat. No. 4,942,870 (Portable Dental Cleaning System), the cleaning system is connected to a faucet's nozzle and secured by a clip at the nozzle. Again, the fitting only works with a certain type of faucets.

It is therefore desirable to have a water flosser that can fit and work with all types of water faucets.

### SUMMARY OF THE INVENTION

A portable water flosser or dental cleaning device, which directs water from a faucet onto teeth without using an electrically operated pump, is made of a hose, a water jet tip member, and a tightening means. The hose has a small and a large end. The hose at its small end is coupled with the water jet tip member and at its large end is loosely fit onto the neck of the faucet, leaving the faucet's nozzle completely inside the hose. The hose is fastened around the faucet's neck by the tightening means, which can be a piece of rope or an elastic cord ring or a rubber band.

Other objectives and further advantages and benefits associated with this invention will be apparent to those skilled in the art from the description, examples, and claims that follow.

### BRIEF DESCRIPTION OF THE DRAWINGS

Preferred forms of the invention are described with reference to the accompanying drawings.

FIG. 1 is a perspective view of the portable cleaning device while fit onto a faucet.

FIG. 2 is another view of the portable cleaning device while detached from the faucet.

### DETAILED DESCRIPTION OF THE INVENTION

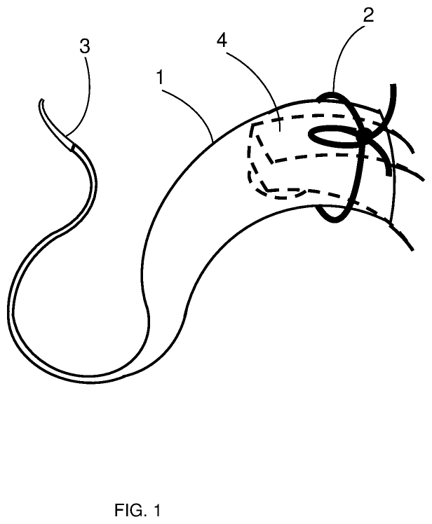

FIG. 1 is an embodiment of the invention. A hose 1 has a small and a large end. The hose at its small end is coupled with a water jet tip member 3 and at its large end is loosely fit onto the neck of the faucet 4, leaving the faucet's nozzle completely inside the hose. The hose is fastened around the faucet's neck by a tightening means 2, which can be a piece of rope or an elastic cord ring, so the faucet water is directed to the water jet tip member. Since the hose is fastened around the faucet's neck, not at the faucet's nozzle, it can fit and work with all types of faucets.

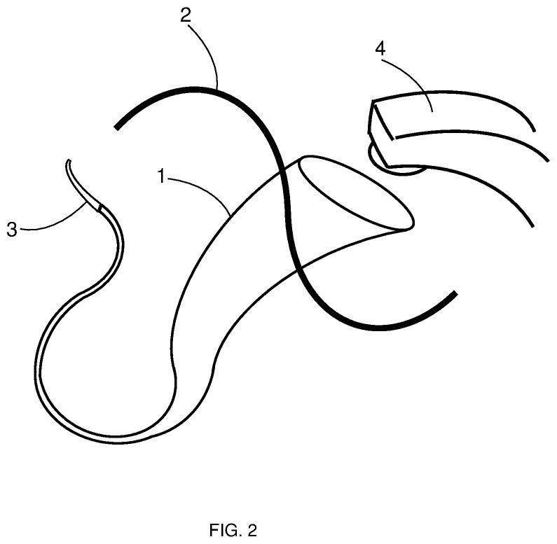

FIG. 2 is the same as FIG. 1 except with the hose detached from the faucet for easy viewing. As can be seen from FIG. 2, the invention can fit and work with all types of faucets.

The invention has been described in preferred forms and method by way of examples. It will be understood by those skilled in the art that various changes and modifications may be made to the embodiments without departing from the sprit or scope of the invention. It is not intended that the invention be limited in any way to the embodiments shown and described herein and it is intended that the invention be limited only by the claims appended hereto.

What is claimed is:

1. A portable dental cleaning apparatus that directs water from a faucet onto teeth in mouth, comprising:
a flexible conduit that, with one opening being larger than the head of said faucet, is loosely fit onto the neck of said faucet, leaving the faucet's nozzle completely inside the flexible conduit;
a tightening means that fastens the flexible conduit around the neck of said faucet; and
a water jet tip member coupled with the flexible conduit.

2. The dental cleaning apparatus of claim 1, where said tightening means is a piece of rope.

3. The dental cleaning apparatus of claim 1, where said tightening means is a clip.

4. The dental cleaning apparatus of claim 1, where said tightening means is an elastic cord ring or a rubber band.
